(19) United States
(12) Patent Application Publication
(10) Pub. No.: US 2014/0217121 A1
(43) Pub. Date: Aug. 7, 2014

(54) Movable fluid dispenser system for refrigerator

(71) Applicant: Francisco Javier Villate Fernandez, Asuncion (PY)

(72) Inventor: Francisco Javier Villate Fernandez, Asuncion (PY)

(21) Appl. No.: 13/760,030

(22) Filed: Feb. 5, 2013

(51) Int. Cl. B67D 7/80

(52) U.S. Cl. CPC B67D 3/0009
USPC 222/146.6

(57) ABSTRACT

The system is a movable, portable fluid dispenser that attaches to an appliance like a refrigerator. The system is comprised of a non-refrigerated fluid source located in a non-refrigerated area; a fluid container with fluid located within a refrigerated area; fluid passage device and; a base and bracket that house dispenser valves located in the non-refrigerated area. The fluid dispenser base and bracket has movable attach device allows it to be attached on the refrigerator door. The dispenser valve housing can be moved to any position on the refrigerator door.

### CROSS-REFERENCES TO RELATED APPLICATIONS (IF ANY)

None.

### STATEMENT AS TO RIGHTS TO INVENTIONS MADE UNDER FEDERALLY-SPONSORED RESEARCH AND DEVELOPMENT (IF ANY)

None

### BACKGROUND OF INVENTION

1. Field of the Invention

This system and apparatus refers to the field of cooled liquid dispenser systems; more specifically a system that can work with existing appliances.

2. Background

As it is known in the state-of-the-art of the cooled liquid dispenser systems located in a cavity in the door in some refrigerators models. Refrigerators with this feature are higher range models and they have an additional cost to refrigerators models due to the implementation of this dispensing system imply. This current kind of fluid dispensing systems described above are used in a wide variety of refrigerators models but they add additional costs and space limitations in order to locate the liquid storage equipment and distribution system within the refrigerator cabinet.

There is still room for improvement in the art.

### SUMMARY OF THE INVENTION

This system is a movable/portable fluid dispenser for an appliance like a refrigerator. It is comprised of fluid transport means, such as a hose or conduct, connected one end to a non-refrigerated fluid source located in a non-refrigerated area; a fluid container with fluid located within a refrigerated area; fluid passage device and; a base/bracket that house dispenser valves located in the non-refrigerated area. The fluid dispenser base/bracket has movable attach device allows it to be attached on the refrigerator door. The dispenser valve housing can be moved to any position on the refrigerator door.

### LIST OF PARTS

### # Description

8 Refrigerator cabinet
10 Refrigerator door
12 Movable dispenser bracket

### 13 Adhesive Magnets (Self Adhesive)

14

a) Cool water dispenser faucet

b) Fresh water dispenser faucet

### 15 External Water Container

16 Refrigerator handle

### 17 Facility Faucet

18 Outer circular return duct
20 fluid passage device
21 Duct self adhesive support
22 Main outer supply duct
23 Volume control valve
24 Secondary outer supply duct
25 rotating absorber

### 26 Connector T

27 Pivot connector
28 Fresh fluid source
29 fluid surface
30 Internal container
32 Internal container cap
34 Discharge tube
35 Discharge tube Filter
36 Container Inlet port
37 fresh fluid supply orifice
38 Container Outlet port
39 Discharge cap orifice
42 Internal circular return duct
48 Hollow support device
49 self adhesive film

self adhesive film

50 Refrigerator seal
52a) Rectangular supply duct

b) Rectangular supply duct

54a) Rectangular return duct

b) Rectangular return duct

60 Frame outer fluid supply
60 float valve for water dispenser

### BRIEF DESCRIPTION OF THE DRAWINGS

Without restricting the full scope of this invention, the preferred form of this invention is illustrated in the following drawings:

FIG. 1 is an exploded view of the device demonstrating its 4 basic units;

FIG. 2a is a front view of the appliance;

FIG. 2b is a front view of the appliance with the invention;

FIG. 3a is a front perspective view of the invention;

FIG. 3b is a front perspective view of the invention with a fluid container;

FIG. 4 shows the Fluid Passage device outside the appliance;

FIG. 5a Front view without refrigerator cabinet/door;

FIG. 5b Rear view without refrigerator cabinet/door;

FIG. 6a shows the inside of the appliance:

FIG. 6b shows the Fluid Passage device inside the appliance;

FIG. 7 displays the door water flow;

FIG. 8 displays the door water flow components;

FIG. 9a displays a side view of the water flow components with a hose;

FIG. 9b displays a front view of the water flow components.

FIG. 10a shows a Refrigerator gasket cutter tool;

FIG. 10b also shows a Refrigerator gasket cutter tool;

FIG. 10c also shows a Refrigerator gasket cutter tool;

FIGS. 11a, 11b and 11c shows an alternative embodiment where a container is used as the water source;

FIG. 12a shows a side view of the Container Outlet port; and

FIG. 12b shows the cap view of the Container Outlet port.

### BRIEF DESCRIPTION OF THE PREFERRED EMBODIMENTS

There are a number of significant design features and improvements incorporated within the invention.

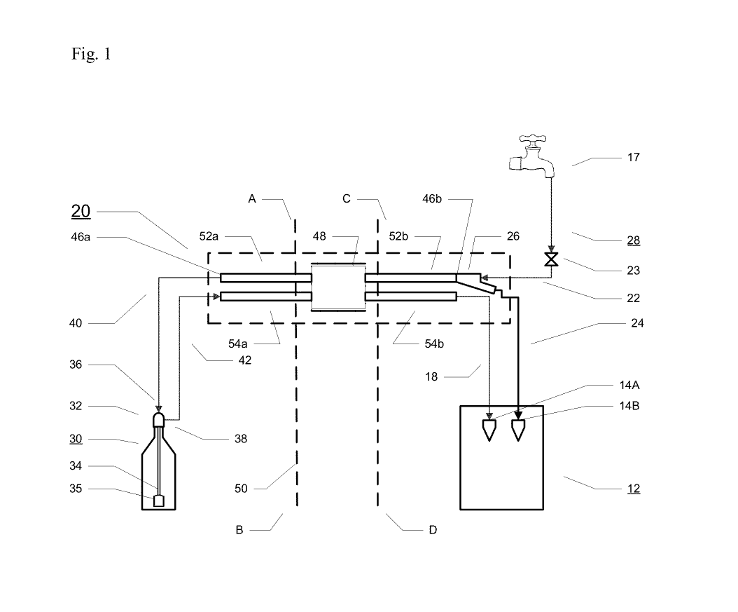

The device and system of the current invention is a movable/portable fluid dispenser 20 for an appliance such as a refrigerator 8 (as shown in FIG. 1), it is comprised of fresh fluid transport mean such as a hose or conduct connected at one end to a non-refrigerated fluid source located in a non-refrigerated area; a fluid container 30 of the said fluid located within a refrigerated area; fluid passage device 20 and; a fluid dispenser base/bracket 12 that defines a housing for dispenser valves (14(a) and 14(b)) located in the non-refrigerated area wherein the fluid dispenser base/bracket has movable attach device allows is being attached on the refrigerator door. The dispenser valves housing 12 can be moved to any position on the refrigerator door.

FIG. 1 shows a block diagram of the fresh fluid flow path. The fresh water, which may be supplied from public facilities (a faucet 17 as a fresh water source is shown but not a water filter device) through fluid transport mean 28 that is connected at one end to the connector “T” 26, where the fluid has two equally possible way: i) first, to the dispenser 14 (b) to be used by a consumer and, ii) secondly, enter into the fluid passage device 20. With this configuration no additional pump device is needed and no electricity power is needed.

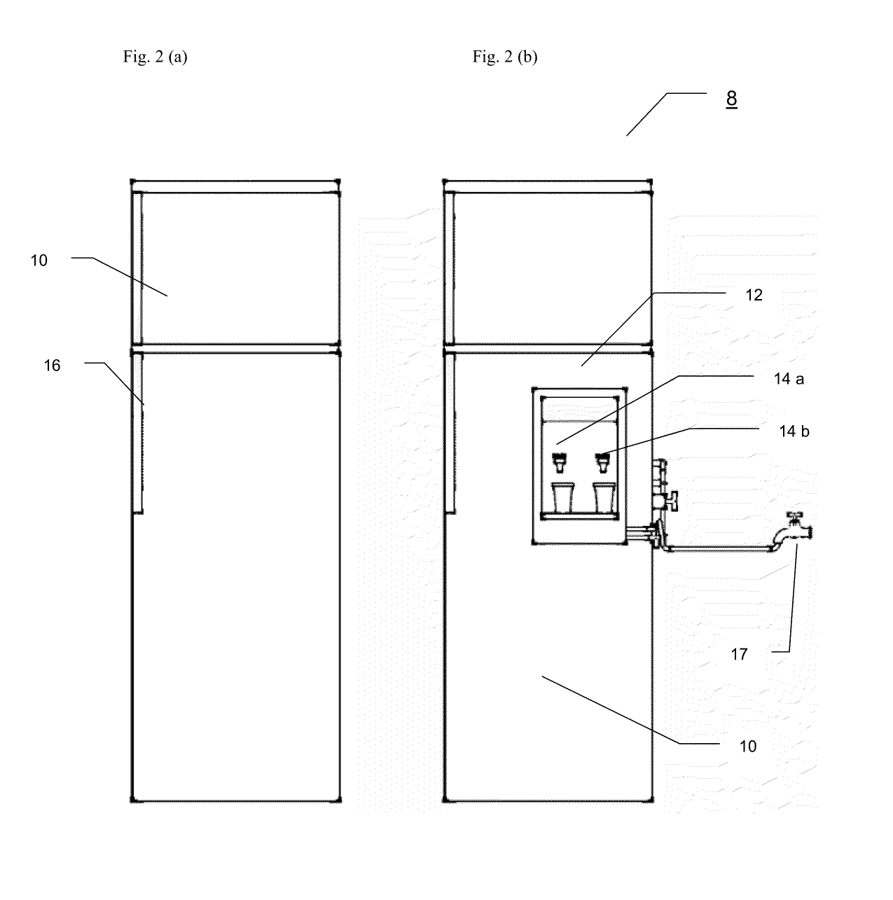

FIG. 2a displays the front of the appliance which in the preferred embodiment is a refrigerator 8 with a refrigerator door 10 and a refrigerator handle 15 to open the refrigerator door 10.

FIG. 2b shows the front of the appliance 8 with the current invention attached with the cool water dispenser faucet 14a and the fresh water dispenser faucet 14b with the invention being connected to a faucet 17.

As shown in FIGS. 2a and 2b, The movable/portable dispenser bracket 12 is mounted on a surface (refrigerator door 8) using an attachment means such as a magnetic attachment system 13 although other connection means can be used such as screws. Preferably lightweight material must be used to assembly this movable/portable dispenser system.

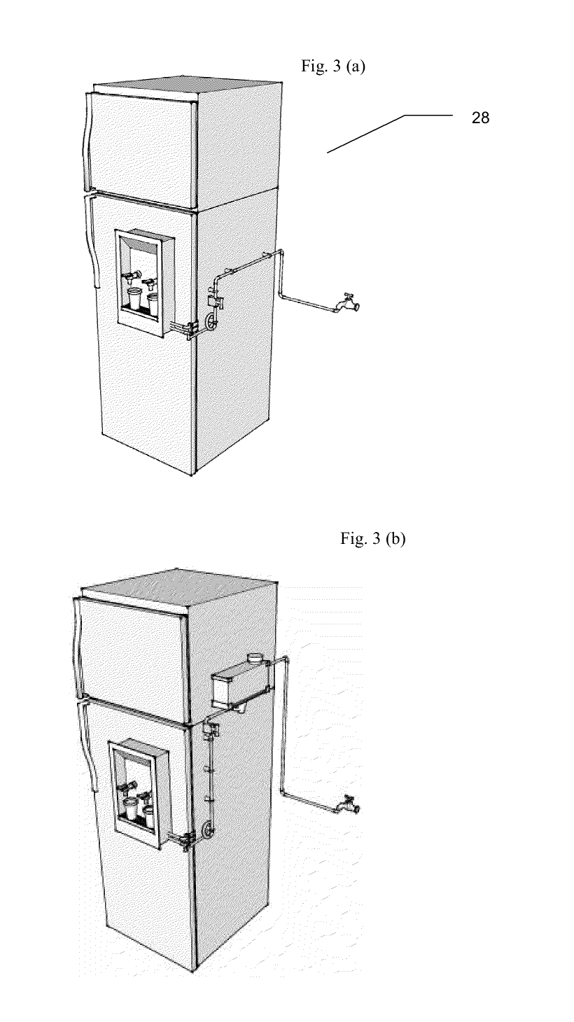

FIG. 3a shows one of the preferred embodiments of the invention with the device being directly being connected to the faucet as a fresh fluid source 28.

FIG. 3b shows an alternate embodiment with an external water container 15 which can be connected to the faucet but can be a stand alone as the liquid source without being connected to faucet or other external source.

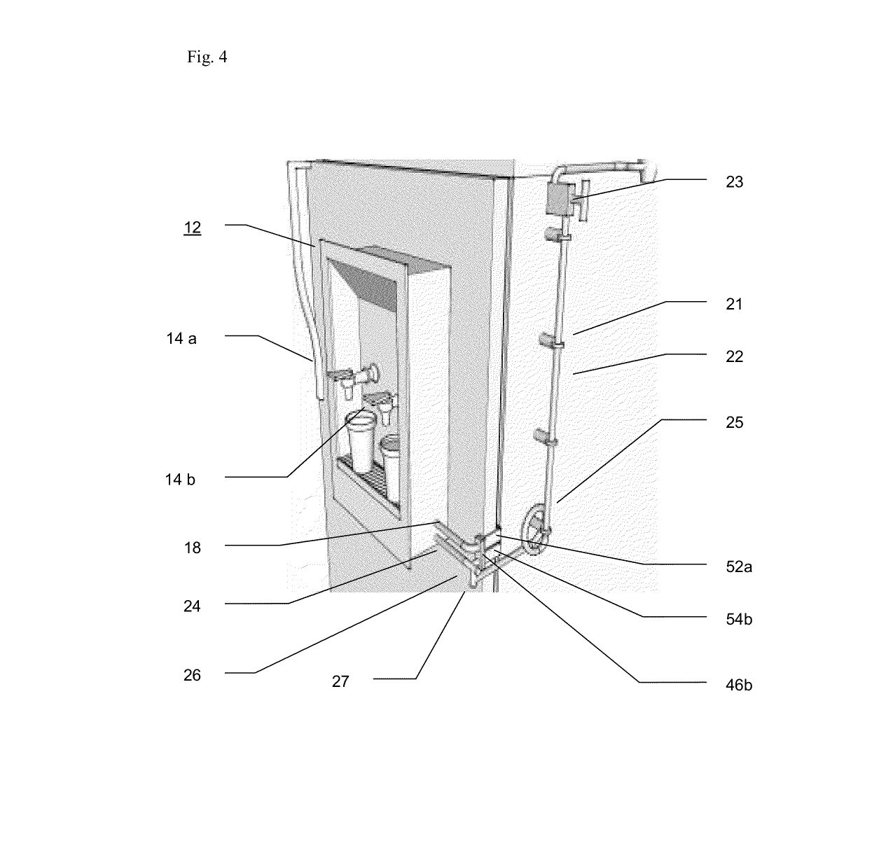

A close up of the system and device is shown in FIG. 4 on how it is connected and used on a standard refrigerator 8 on the refrigerator door 10. The liquid supply comes from the fresh water supply 28 through the main outer supply duct 22. The main outer supply duct 22 has a volume control valve 23 which controls the volume of liquid coming from the fresh water supply 28. The main outer supply duct 22 is attached, in the preferred embodiment to the refrigerator 8 by duct self adhesive supports 21 although other connection means may be used.

The main outer supply duct 22 connects to a pivot connector 27 which then connects to a connector T which splits the water flow into the secondary outer supply duct 24 and the rectangular supply duct 52b. The secondary outer supply duct 24 provides the liquid to the fresh water dispenser faucet 14b which is in the movable dispenser bracket 12. Both rectangular supply duct 52a and 52b supplies liquid into the refrigerator 8 through the refrigerator seal 50. Both rectangular return duct 54b and 54a supplies cold liquid to the cool water dispenser faucet 14b after being cooled in the refrigerator 8 as described below.

FIGS. 5a and 5b should the side and back of the movable dispenser bracket 12 which in the preferred embodiment is connected to the refrigerator 8 by adhesive magnets 13 although another connection method can be used.

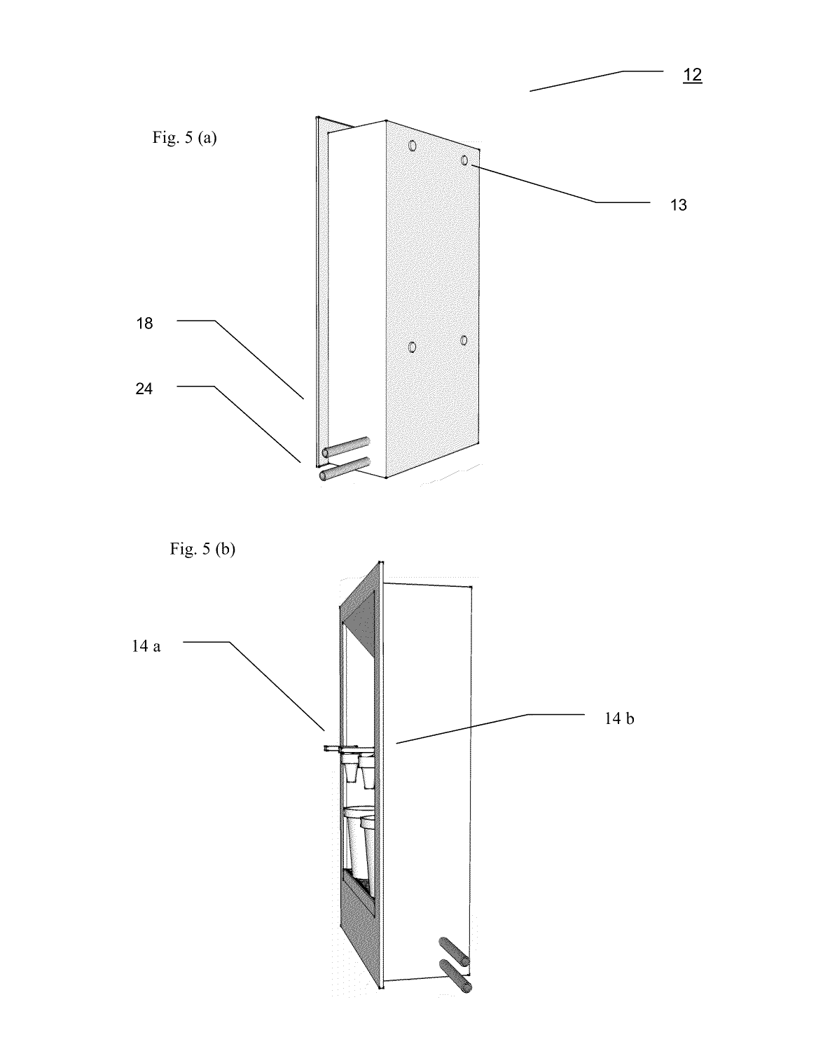

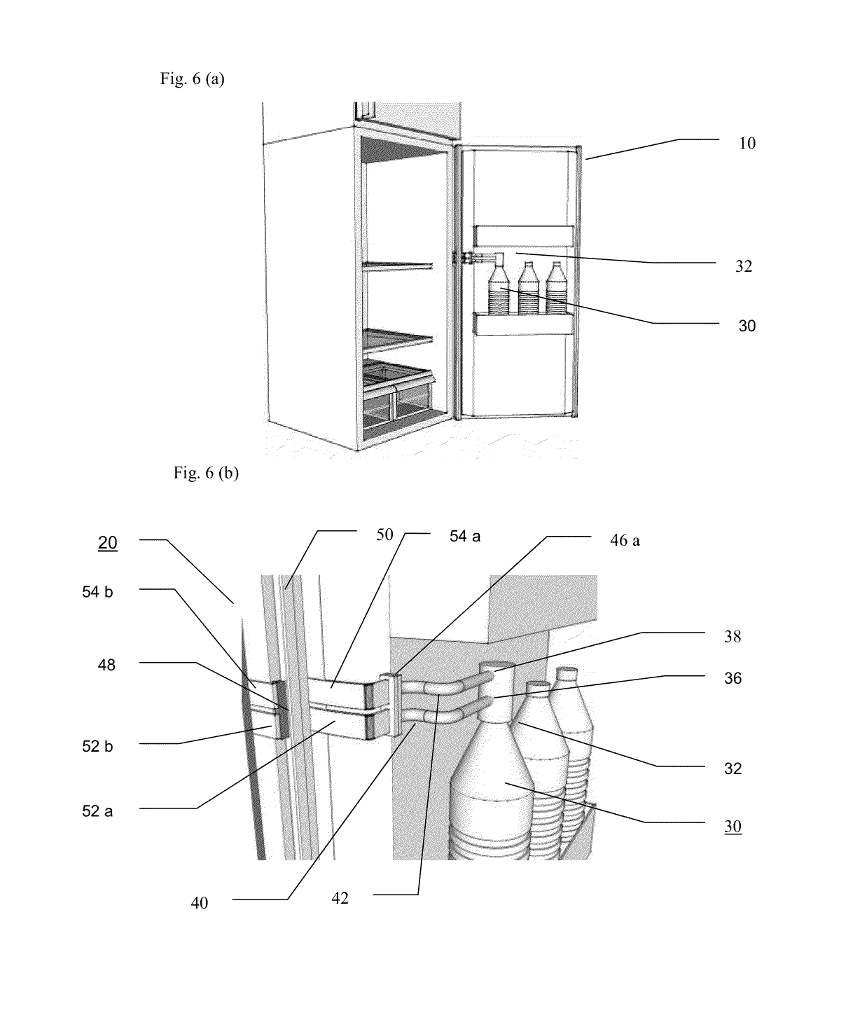

FIGS. 6a and 6b shows one method of cooling the liquid where both rectangular supply duct 52a and 52b supply liquid into the refrigerator 8 through the refrigerator seal 50 to internal container cap 32 into the internal container 30 located on the refrigerator door 10 and from the internal container 30 through the container cap 32 to the rectangular return duct 54a. The liquid stored in the internal container 30 will be cooled by the refrigerator 8.

FIG. 7 shows more detail on the cooling system and the components of the fluid passage device 20. The rectangular supply duct 52a and 52b supplies liquid into the refrigerator 8 through the refrigerator seal 50 through the internal circular supply duct 40 the container inlet port 36 and the internal circular supply duct 40 is connected to internal container cap 32 into the internal container 30 located on the refrigerator door 10 and from the internal container 30 through the container cap 32 to the rectangular return duct 54a and 54b via the internal circular return duct 42 and connected by the container outlet port 38. The liquid stored in the internal container 30 will be cooled by the refrigerator 8. Multiple internal containers 30 can be stored on the refrigerator door 10 increasing the storage capacity. The rectangular return duct 54a and 54b and rectangular supply duct 52a and 52b are supported mechanically by the hollow support device 48.

As shown in FIG. 1, the current embodiment has a key element called or described as a “fluid passage device” 20, which allows it enter into the refrigerated area (rectangular shape with dotted line in FIG. 1) through the door seal 50 (or refrigerator door gasket) by a thin and rectangular supply duct 52b and 52a. The refrigerator seal has a air chamber (air is a excellent thermal insulator, low thermal conductivity), allowing it to be used to install means such as hollow support device 48, said hollow support is supporting said rectangular supply duct 52a, 52b and rectangular return duct 54a and 54b whereby cold water is transported from internal container 30 (refrigerated area) to the dispenser 14a (non-refrigerated area).

As shown in FIGS. 7 and 8, a rectangular shaped duct is used instead of a circular shaped duct. The rectangular cross section shaped duct has two variables (width; height) and allows minimize width dimension to a minimal length increasing height dimension. The main requirement in order to maintain a constant water volume passage through the fluid passage device 20 and avoid a “bottleneck” is maintain circular cross section area and rectangular cross section area equal.

The rectangular supply duct 52a and 52b as the rectangular return duct 54a, 54b wall and cross section are very thin in order to facilitate their installation allowing properly door closing and avoid thermal leakage between both area: non-refrigerated to refrigerated area.

FIG. 8 shows the fluid passage device 20 from the top. The fluid passage device 20 is unique to this invention and is a huge advancement over prior art. The rectangular supply duct 52a and 52a and the rectangular return duct 54a and 52b have a unique shape that allows them to run through the refrigerator seal 50 while allowing the seal 50 to be sealed containing the cool air in the refrigerator 8. The rectangular supply duct 52a and 52b and the rectangular return duct 54a and 54b run through the hollow support device 48. The rectangular supply duct 52a and 52b supply liquid into the refrigerator 8 through the refrigerator seal 50 through the internal circular supply duct 40. The pivot connector 27 turns to allow the fluid passage device (20) to turn with the door 8 when opened.

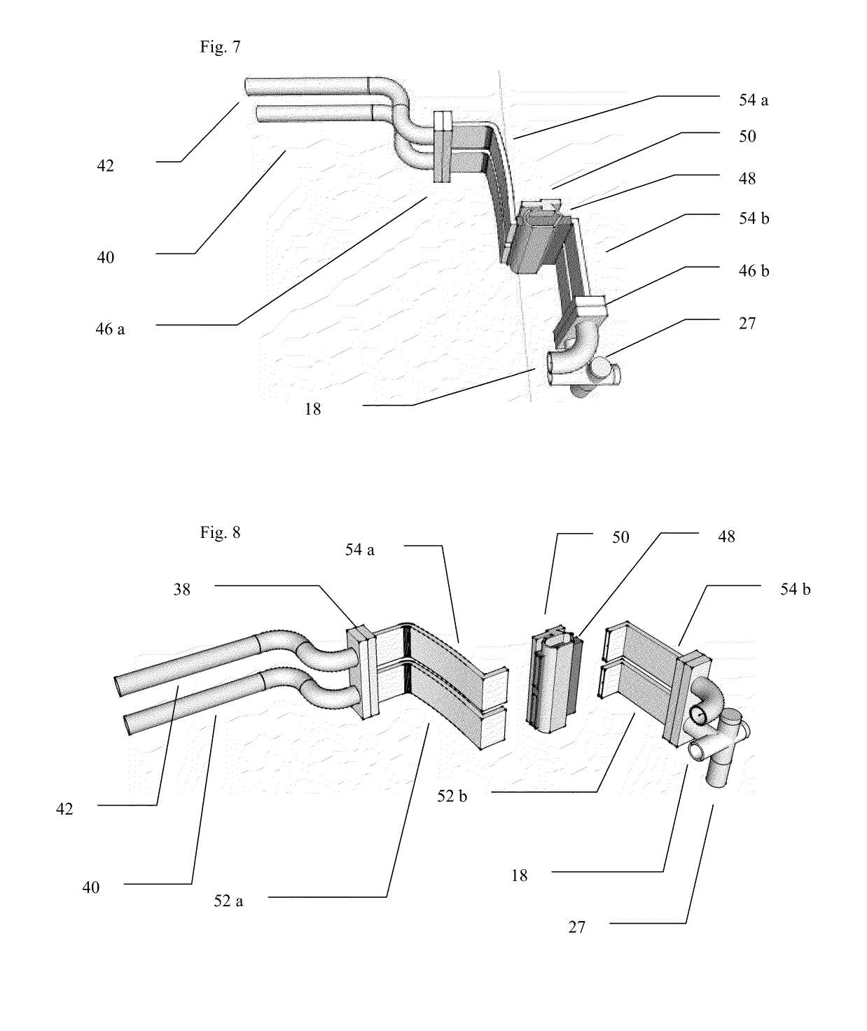

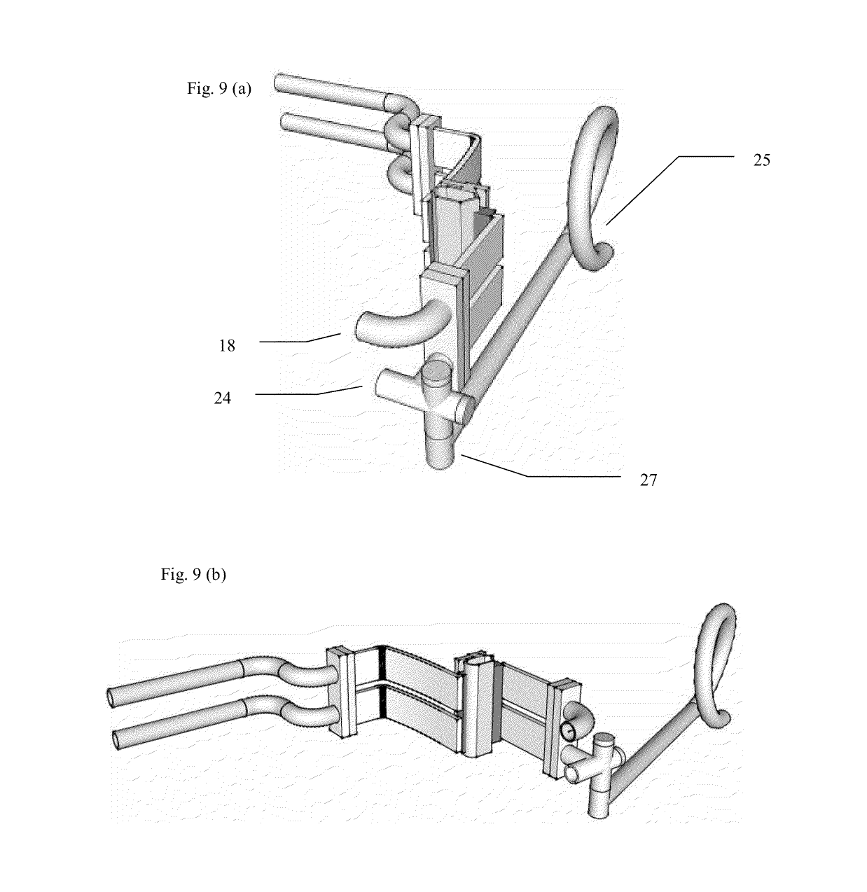

FIG. 8 shows the components of the fluid passage device (20) separated from each other while FIGS. 9a and 9b shows the fluid passage device (20) with the pivot connector 27 being attached to the rotating absorber 25.

FIG. 7 shows the fluid Passage device (20). The rectangular supply duct 52a is connected to internal circular supply duct 40 in the section 46a and the water supply circuit is connected to a container inlet port 36 where it enters into the internal container 30. The internal container 30 design hasn't special requirement and may be used a refillable steel container or commercial plastic water or soft drink bottles (e.g.: PET,

Polyethylene Terephthalate). Then, they can be safely reused if cleaned and handled properly. A special and adaptable cap 32 is provided to be used to discharge to and return water from the internal container 30.

As a result of water density differences in the internal container 30, the cooled water is positioned to the bottom level and the top level is covered by refilled water. This internal water container 30 (FIG. 1) is maintained filled and under pressure all time, which enables water flows through a discharge tube 34 and discharge tube filter 35 (FIG. 1) and then the discharge tube 34 is connected to the internal circular return duct 42 by outlet port 38. This flow only takes place when the dispenser 14a is being activated/triggered by the user.

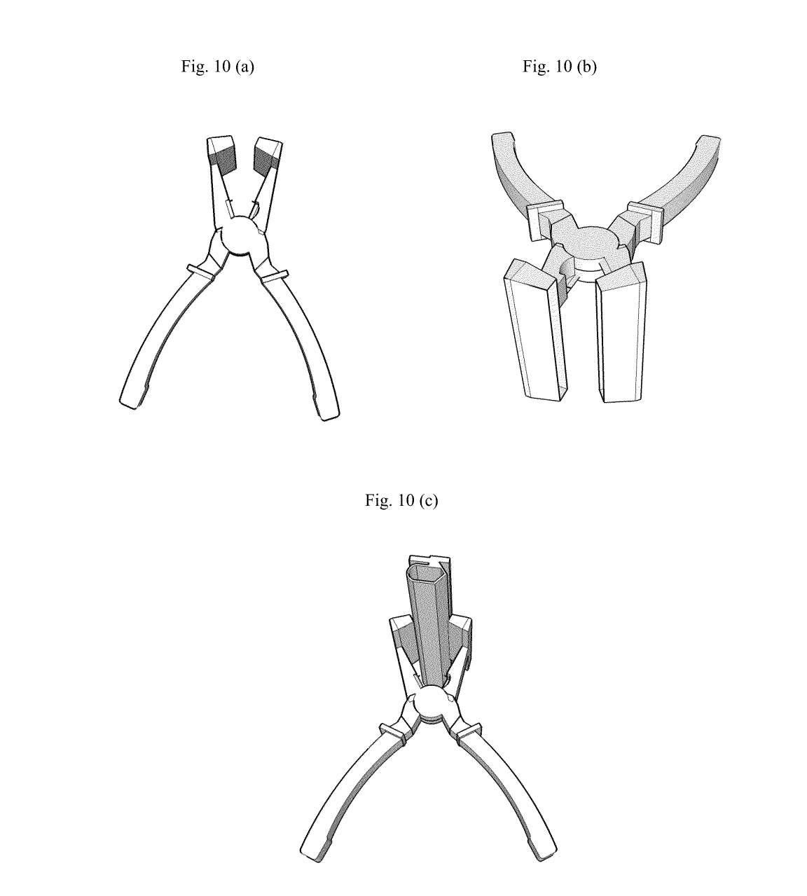

As shown in FIGS. 10a, 10b and 10c a specialized refrigerator gasket cutter tool 110 is provided in order to perform a standardized cutting task. The Refrigerator seal cutter tool 110 comprises two pivoting arms mounted together by means of a pin being free movement both in a plane perpendicular to the axis of said pin, at the lower end of each arm has a handle, characterized in that one arm has an upper end cutting edges or cutting head whose conformation describes how the outer perimeter of the hollow body fluid passage device and the upper end of the other arm defines a housing open in the shape of the silhouette the outer perimeter of the hollow body of the device for passage of fluid and predetermined depth so that the inner surface of said housing to receive snugly the cutting edges of the other said arm having an effect on the shear seal piece which lies between the two arms.

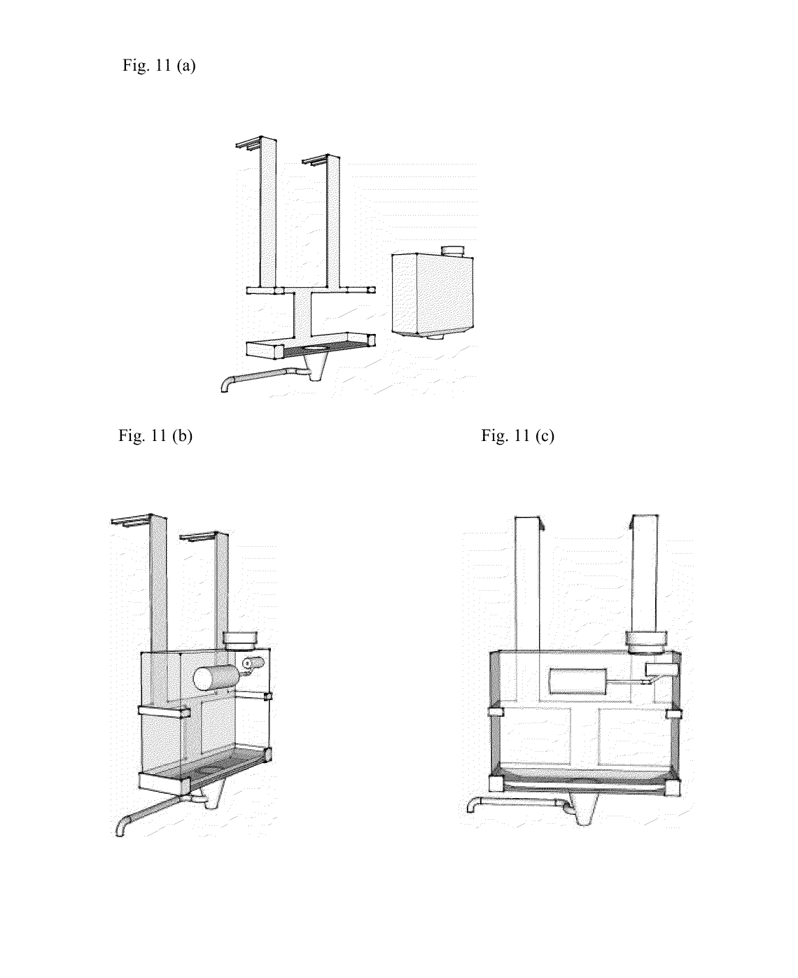

FIGS. 11a, 11b and 11c shows an alternative embodiment of using an external water container 15 which can be connected to a faucet but can be stand alone as the liquid source without being connected to faucet or other external source. The external water container 15 has a fill opening at the top with a cap. Liquid can be filled into the external water container 15 using this opening. In the preferred embodiment there is also a side input to which a connection to an external liquid supply such as a faucet can be connected. This side input would be connected to a float system which would automatically shut off the input stream when the external water container 15 is at the desired fill point. The external water container 15 would have a supply opening at the bottom where the liquid would flow out to the system. The external water container 15 would be held onto the refrigerator 8 by an external water container bracket which would have two arms in the preferred embodiment that would rest on the top of the refrigerator 8 to hold the external water container 15 in place. There would be an external water container duct system that would deliver the liquid from the external water container 15 through the supply opening to the volume control valve 23. The supply opening and the external water container duct system would have a water proof seal at their connection point.

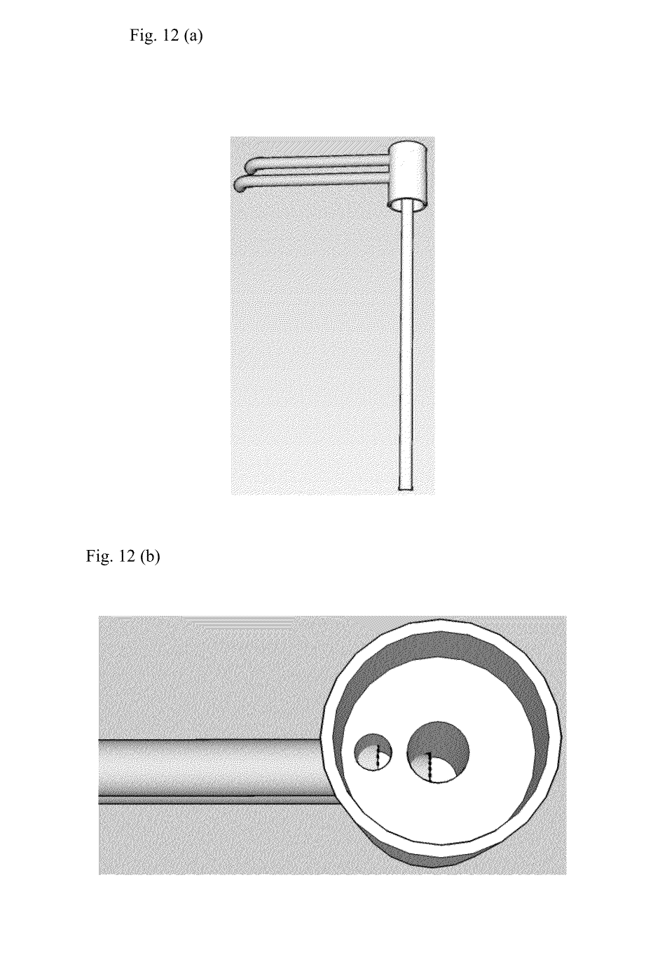

FIGS. 12a and 12b show the internal container cap 32. The internal container cap 32 has the container inlet port 36 going into the internal container 30 to supply the liquid to be cooled. The internal container cap 32 has a discharge tube 34 extending into the internal container 30 through which the liquid flows to the container outlet port 38.

FIG. 12b shows the internal container cap 32 from the bottom showing the openings in the internal container cap 32. The center opening is the discharge tube 34. As shown in FIG. 1 the discharge tube 34 has a filter 35 at the open end of it.

As to a further discussion of the manner of usage and operation of the present invention, the same should be apparent from the above description. Accordingly, no further discussion relating to the manner of usage and operation will be provided.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur by those skilled in the art, it is not desired to limit the invention to the exact construction and operation shown and described, and accordingly, all suitable modifications and equivalents may be resorted to, falling within the scope of the invention.

I claim:

1. A device comprising: a fluid dispenser having, a fluid transportation means connected at one end to a non-refrigerated fluid source located in a non-refrigerated area, providing liquid to through a fluid passage device to a fluid container located within a refrigerated area with the fluid passage device transporting the fluids from the fluid container to a plurality of dispenser valves.

2. A device according to claim 1 further comprising having a fluid dispenser bracket that is a housing for the dispenser valves located in a non-refrigerated area with the dispenser valves being contained in the fluid dispenser bracket.

3. A device according to claim 2 further comprising wherein the fluid dispenser bracket has movable attachment means.

4. A device according to claim 1 further comprising having no power source.

5. A device according to claim 1 further comprising having no pump.

6. A device according to claim 1 further comprising having a volume control valve controlling the volume of liquid coming from the fluid source.

7. A device according to claim 1 further comprising having said fluid passage device having a rectangular shaped supply duct and a rectangular shaped return duct.

8. A device according to claim 1 further comprising having the rectangular shaped supply duct and the rectangular shaped return duct through a refrigerator seal.

9. A device according to claim 1 further comprising having the fluid transportation means have a pivot connector.

10. A device according to claim 1 further comprising having the liquid supply being a container.

11. A process to dispense liquid comprising: a fluid dispenser having a fluid transportation means connected at one end to a non-refrigerated fluid source located in a non-refrigerated area, providing liquid to through a fluid passage device to a fluid container located within a refrigerated area with the fluid passage device transporting the fluids from the fluid container to a plurality of dispenser valves.

12. A process according to claim 11 further comprising having a fluid dispenser bracket with a movable attachment means housing the dispenser valves located in a non-refrigerated area with the dispenser valves being contained in the fluid dispenser bracket.

13. A process according to claim 12 further comprising wherein having the fluid dispenser bracket being movable with a movable attachment means.

14. A process according to claim 11 further comprising having no power source.

15. A process according to claim 11 further comprising having no pump.

16. A process according to claim 11 further comprising having a volume control valve controlling the volume of liquid coming from the fluid source.

17. A process according to claim 11 further comprising having said fluid passage device having a rectangular shaped supply duct and a rectangular shaped return duct running through the a refrigerator seal.

18. A process according to claim 11 further comprising having the fluid transportation means have a pivot connector.

19. A process according to claim 11 further comprising having the liquid supply being a container.

20. A device comprising: a fluid dispenser having, a fluid transportation means connected at one end to a non-refrigerated fluid source located in a non-refrigerated area, providing liquid to through a fluid passage device to a fluid container located within a refrigerated area with the fluid passage device transporting the fluids from the fluid container to a plurality of dispenser valves, having a fluid dispenser bracket that is a housing for the dispenser valves located in a non-refrigerated area with the dispenser valves being contained in the fluid dispenser bracket, having a volume control valve controlling the volume of liquid coming from the fluid source, where the fluid passage device having a rectangular shaped supply duct and a rectangular shaped return duct that run through a refrigerator seal.
